(19) United States
(12) Patent Application Publication
(10) Pub. No.: US 2024/0286383 A1
(43) Pub. Date: Aug. 29, 2024

(54) ION-IMPERMEABLE DIELECTRIC COMPOSITE

(71) Applicant: UNIVERSITY OF MASSACHUSETTS, Boston, MA (US)

(72) Inventors: Tingyi Liu, Amherst, MA (US); Kaushal Sumaria, Amherst, MA (US)

(21) Appl. No.: 18/584,486

(22) Filed: Feb. 22, 2024

Related U.S. Application Data
(60) Provisional application No. 63/448,489, filed on Feb. 27, 2023.

(51) Int. Cl. B32B 15/08; B32B 27/28

(52) U.S. Cl. CPC B32B 15/08; B32B 27/283; B32B 2307/204; B32B 2307/7242; B32B 2383/00

(57) ABSTRACT

A dielectric composite includes a first solid layer; an ion barrier layer including a fluid material on the first layer; and a second solid layer on the ion barrier layer on a side opposite the first solid layer. The ion barrier layer is encapsulated by the first and second solid layers. Advantageously, the dielectric composite is ion impermeable, nanoparticle impermeable, or both. Articles including the dielectric composite are also described.

### CROSS-REFERENCE TO RELATED APPLICATION

This application claims priority to and the benefit of U.S. Provisional Patent Application No. 63/448,489, filed on Feb. 27, 2023, the contents of which are hereby incorporated by reference in their entirety.

### BACKGROUND

Soft and stretchable bioelectronic devices are of interest in biomedical research and have great clinical and societal implications. For example, implantable neural probes track neuronal functions change over time, which can assist in understanding the progression of brain diseases, as well as uncover new insights into development and plasticity that can lead to clinical and practical applications.

For instance, for many psychiatric diseases, including drug and alcohol abuse, which evolve over time, and studying changes in neuronal function in areas such as the frontal cortex or striatum during drug dependence will be incredibly valuable. Monitoring changes in neuronal activity in the cortex and hippocampus during the development of Alzheimer's disease or other forms of age-related dementia will provide an unparalleled understanding of the functional aspect of the disorder. Similarly, observing striatal neuron function during the progression of neurodegenerative diseases like Parkinson's and Huntington's will be of immense value. Furthermore, tracking neuron ensemble activity over development in models of conditions like schizophrenia and autism spectrum disorders will be instrumental in comprehending disease progression.

While implantable bioelectronic devices can provide access to biological systems, their long-term functionality has thus far been limited. Chronic immersion in physiological environments leads to highly concentrated ions diffusing through the dielectric encapsulant commonly made of polymeric materials, causing an electrical short, electrochemical reaction, signal loss, or other malfunction issues in the implantable bioelectronic device.

To prevent the abovementioned failure, an ion-impermeable dielectric is preferred. In general, ceramics are a good ion barrier, but their rigid nature prevents them from being used for soft and stretchable bioelectronics. While ceramics in their wrinkling form can provide sealing capabilities against ions, they are only capable of bearing deformation in one specific direction (i.e., the wrinkle propagation direction), making it impractical for actual applications where stress from biological tissues from random directions will break the wrinkled ceramic seals.

Ion impermeability can have wider applications beyond implantable bioelectronic devices. Since an ion-free condition will prevent electrochemical reactions at the interface, a truly ion-impermeable dielectric will be a platform technology to eliminate corrosion (e.g., on bridges) or realize prolonged electrolysis (e.g., for hydrogen generation).

Accordingly, there remains a continuing need in the art for improved ion impermeable materials.

### SUMMARY

An aspect of the present disclosure is a dielectric composite comprising: a first solid layer; an ion barrier layer comprising a fluid material on the first layer; a second solid layer on the ion barrier layer on a side opposite the first solid layer; wherein the ion barrier layer is encapsulated by the first and second solid layers; and wherein the dielectric composite is ion impermeable, nanoparticle impermeable, or both.

Another aspect is a dielectric composite comprising two or more layers, wherein each layer comprises the dielectric composite above.

Another aspect is an article comprising the dielectric composite.

The above described and other features are exemplified by the following figures and detailed description.

### BRIEF DESCRIPTION OF THE DRAWINGS

The following figures represent exemplary embodiments.

FIG. 1A shows examples of the middle fluid layer with liquid metals (LM) in different forms of film. Three examples of uniform LM layer without supporting structures, hemiwicked LM layer with pillar supporting structures, and oxide-shelled LM as self-supporting layer and shown.

FIG. 1B shows scanning electron micrographs (SEM) of the three examples. LM layer was frozen to solid in order to take an SEM image.

FIG. 2A is a schematic illustration of a hygrosensor.

FIG. 2B shows vapor impermeability test results showing LM can serve as a barrier to block vapor transport through elastomer polydimethylsiloxane (PDMS) film.

FIG. 2C is a plot of mass of absorbed water (milligrams (mg)) versus time (hours).

FIG. 3A shows a theoretical circuit model of vertical ion diffusion in a solid material (i.e., increasing ion penetration depth through the layers).

FIG. 3B shows simulation results of vertical ion diffusion in a solid material (i.e., increasing ion penetration depth through the layers).

FIG. 3C shows experimental results of vertical ion diffusion in a solid material (i.e., increasing ion penetration depth through the layers).

FIG. 4A shows a theoretical circuit model of lateral ion diffusion in a solid material (i.e., broadening ion coverage while maintaining a constant diffusion depth).

FIG. 4B shows simulation results of lateral ion diffusion in a solid material (i.e., broadening ion coverage while maintaining a constant diffusion depth).

FIG. 4C shows experimental results of lateral ion diffusion in a solid material (i.e., broadening ion coverage while maintaining a constant diffusion depth).

FIG. 5A shows a theoretical circuit model and simulation results of the dielectric composite layers. Circuit modeling of two solid layers with a fluid layer amid. Ions are diffusing in the solid layer #2 as it is directly contacting the high conductivity solution. However, the fluid layer (ion barrier) and the solid layer #1 are free of ions as ions cannot percolate through the ion barrier fluid layer.

FIG. 5B shows simulation results of poly(dimethylsiloxane)-liquid metal-poly(dimethylsiloxane) (PDMS-LM-PDMS) layers under dry, wet, and long-soaked conditions. All three cases show similar impedance because the ion barrier fluid layer effectively blocks the ion percolation and maintains the inner solid layer (i.e., solid layer #2) ion-free and thus with high impedance.

FIG. 6 shows the experiments and results that verify LM, air, and dielectric fluid serving as the fluid layer by successfully stopping ion diffusion between two segments of hydrogel, which is a highly ion-permeable material. (a) Reference experiment with hydrogel only without the ion barrier fluid layer. (b) Experiment to test hydrogel-LM-hydrogel layers. (c) Experiment to test hydrogel-air-hydrogel layers. (d) Experiment to test hydrogel-PDMS₍₁₎₋ hydrogel layers.

FIG. 7A shows hydrogel without any fluid layer as an ion barrier allowed dyes to diffuse from left to right.

FIG. 7B shows hydrogel-LM-hydrogel layers showing that LM blocked dye diffusion from left to right.

FIG. 7C shows hydrogel-air-hydrogel layers showing that air blocked dye diffusion from left to right.

FIG. 7D shows hydrogel-PDMS₍₁₎-hydrogel layers showing that PDMS₍₁₎ blocked dye diffusion from left to right.

FIG. 8A shows the results of continuous conductivity measurement of water on the right-side tube of FIG. 6. Ions leaked through hydrogel and increased the water conductivity exponentially.

FIG. 8B shows the results of continuous conductivity measurement of water on the right-side tube using LM as the fluid layer. The LM fluid layer successfully stopped the ion diffusion between two segments of hydrogel and maintained the low conductivity of water in the right tube.

FIG. 8C shows the results of continuous conductivity measurement of water on the right-side tube using air as the fluid layer. The air fluid layer successfully stopped the ion diffusion between two segments of hydrogel and maintained the low conductivity of water in the right tube.

FIG. 8D shows the results of continuous conductivity measurement of water on the right-side tube using PDMS(1) as the fluid layer. The PDMS fluid layer successfully stopped the ion diffusion between two segments of hydrogel and maintained the low conductivity of water in the right tube.

FIG. 9 shows a schematic of an aspect of the dielectric composite without supporting structures in the fluid layer.

FIG. 10 shows a schematic of an aspect of the dielectric composite with supporting structures in the fluid layer.

FIG. 11 shows a schematic of an aspect of the dielectric composite as a continuous fluid layer.

FIG. 12 shows a schematic of an aspect of the dielectric composite including pillar supporting structures in the fluid layer.

FIG. 13 shows a schematic of an aspect of the dielectric composite including grating supporting structures in the fluid layer.

FIG. 14 shows a schematic of an aspect of the dielectric composite including hexagonal supporting structures in the fluid layer.

FIG. 15 shows a schematic of an aspect of the dielectric composite including random supporting structures in the fluid layer.

FIG. 16 shows a schematic of an aspect of the dielectric composite including fluidic self-supporting structures in the fluid layer.

### DETAILED DESCRIPTION

Reducing the mechanical and electrical mismatches between soft tissues and electronics is an important factor in enabling long-term single-cell resolution in vivo bioelectronic interrogation and intervention. So far, reducing such mismatch requires bioelectronic devices (e.g., wearable or implantable) to either increase the conductivity of soft polymeric conductors or reduce the modulus of rigid circuits. To increase the conductivity of a soft polymer, synthetic approaches that exploit specialized chemistries and their composites have been explored. To reduce the modulus of conventional rigid circuit materials, engineering approaches that exploit structural mechanics to transfer ultra-thin semiconductors and metals on flexible or stretchable substrates have been investigated. However, these approaches involve trade-offs between mechanical deformability and electrical conductivity, where the improvement of one was made at the expense of the deterioration of the other.

Taking advantage of the metal-like high conductivity but fluid-like unlimited stretchability, nontoxic gallium-based liquid metals (LM) alloys have recently been incorporated with intrinsically stretchable polymers to minimize the compromise between mechanical and electrical performance. See, e.g., Geratherm Medical AG. Galinstan Safety Data Sheet. http://www.rgmd.com/msds/msds.pdf (2011); Liu, T., Sen, P. & Kim, C.-J. Characterization of nontoxic liquid-metal alloy Galinstan for applications in microdevices. J. Microelectromechanical Syst. 21, 443-450 (2012); Dickey, M. D., Chicchi, R. C., Larsen, R. J., Weiss, E. A., Weitz, D. A. & Whitesides, G. M. Eutectic Gallium-Indium (EGaIn): A Liquid Metal Alloy for the Formation of Stable Structures in Microchannels at Room Temperature. Adv. Funct. Mater. 18, 1097-1104 (2008); Minev, I. R., Musienko, P., Hirsch, A., Barraud, Q., Wenger, N., Moraud, E. M., Gandar, J., Capogrosso, M., Milekovic, T., Asboth, L., Torres, R. F., Vachicouras, N., Liu, Q., Pavlova, N., Duis, S., Larmagnac, A., Vörös, J., Micera, S., Suo, Z., Courtine, G. & Lacour, S. P. Electronic dura mater for long-term multimodal neural interfaces. Science 347, 159-163 (2015); Liu, Y., Liu, J., Chen, S., Lei, T., Kim, Y., Niu, S., Wang, H., Wang, X., Foudch, A. M., Tok, J. B.-H. & Bao, Z. Soft and elastic hydrogel-based microelectronics for localized low-voltage neuromodulation. Nat. Biomed. Eng. 3, 58-68 (2019). However, while liquid metal alloys can reduce the mechanical and electrical mismatch between electronics and biological systems, there exists a fundamental challenge in bioelectronics where the stretchability of encapsulating polymers is inherently coupled with permeability which leads to a degrading/leaky dielectric interface under physiological conditions over time.

To address this electrochemical limitation, the present inventors sought to exploit the unique properties of liquid metals beyond their common utilization, as well as other fluids that are intrinsic soft and stretchable materials and address the prevailing issues in stretchable bioelectronics.

Accordingly, an aspect of the present disclosure is a dielectric composite. The dielectric composite comprises a first solid layer, an ion barrier layer on the first solid layer, and a second solid layer on the ion barrier layer on a side opposite the first solid layer.

The first solid layer and the second solid layer may have the same or different compositions. In an aspect, the first solid layer and the second solid layer have the same composition. In an aspect, the first solid layer and the second solid layer have different compositions. The first solid layer and the second solid layer can be of the same or different thicknesses. In an aspect, the first solid layer and the second solid layer can each independently have a thickness of 1 nanometer to 10 centimeters, or 100 nanometers to 1 centimeter, or 500 nanometers for 1 centimeter, or 1 micrometer to 1 centimeter, or 1 micrometer to 500 micrometers, or 1 micrometer to 100 micrometers.

The first solid layer and the second solid layer can each independently comprise soft or rigid materials. Exemplary soft materials can include a hydrogel, a rubber, an elastomer, and the like. Exemplary rigid materials can include a rigid thermoplastic material, a rigid thermoset material, a ceramic material, and the like.

In an aspect, the first solid layer and the second solid layer can each independently comprise a hydrogel. The hydrogel can be chemically crosslinked, physically crosslinked, or both (e.g., a hybrid or a double network hydrogel). Exemplary hydrogels can include those formed from poly(vinyl alcohol) (PVA), poly(acrylamide) (PAA), polyethylene glycol (e.g., polyethylene glycol diacrylate (PEGDA)), alginate-based networks, and the like. In an aspect, the hydrogel can have an elastic modulus of, for example, 0.1 kilopascal (kPa) to 100 megapascal (MPa).

In an aspect, the first solid layer and the second solid layer can each independently comprise an elastomer. Exemplary elastomers can include polysiloxane, polydimethylsiloxane, silicone, polyurethane, polyacrylate, natural latex rubber, block copolymer elastomers, poly(styrene-ethylene-butylene-styrene), thermoplastic elastomers, propylene-ethylene copolymer, fluoroelastomers, or a combination thereof. In a specific aspect, the elastomer can comprise poly(dimethylsiloxane) elastomer.

In an aspect, the first solid layer and the second solid layer can each independently comprise a rigid thermoplastic material or a rigid thermoset material. The thermoplastic and/or thermoset can be selected from numerous materials. Exemplary materials can include polytetrafluoroethylene (PTFE), poly(methyl methacrylate) (PMMA), polyimide (PI), or an epoxy (e.g., SU-8 epoxy).

In an aspect, the first solid layer and the second solid layer can each independently comprise a ceramic material. Exemplary ceramics that can be useful for the present composite include silica, alumina, and the like, and combinations thereof.

The dielectric composite of the present disclosure comprises an ion barrier layer disposed between the first solid layer and the second solid layer. In an aspect, the first solid layer and/or the second solid layer can be disposed directly on the respective sides of the ion barrier layer. In an aspect, an intervening layer may be disposed between the ion barrier layer and the first solid layer, between the ion barrier layer and the second solid layer, or between the ion barrier layer and the first solid layer and between the ion barrier layer and the second solid layer. Intervening layers will be discussed in further detail below. The ion barrier layer is encapsulated by the first and second solid layers. Stated another way, the first and second layers can be in direct contact with each other (or with intervening layers, if present) at the edges of the composite.

The ion barrier layer comprises a fluid material. The fluid material can comprise a liquid metal, a gas, a nonionic liquid, or a combination thereof.

In an aspect, the fluid material can comprise a liquid metal. The liquid metal can preferably have a melting temperature of less than 100° C., or less than 50° C., or less than 37° C. Exemplary liquid metals can include gallium, indium, tin, bismuth, mercury, or an alloy thereof. In an aspect, the liquid metal is gallium or an alloy thereof.

In an aspect, the fluid material can comprise a gas. Suitable gases can include but are not limited to air, oxygen, nitrogen, argon, or a combination thereof. In an aspect, the fluid material comprising a gas can comprise air.

Other suitable fluid materials can include, for example, fluorinated fluids, organic fluids, or a combination thereof. Exemplary fluorocarbons/fluorinated fluids can include, but are not limited to, KRYTOX oils, (commercially available from The Chemours Company), FOMBLIN oils (commercially available from Solvay), FLUORINERT Electronic Liquids such as FC-40 and FC-72 (commercially available from 3M), NOVEC 6000 (commercially available from 3M). In an aspect, the fluid can exclude a fluorinated fluid. Organic fluids that are compatible with the first and second solid material layers can also be used. Exemplary organic fluids can include, but are not limited to, mineral oils, silicone fluids (such as a poly(dimethylsiloxane) polymer fluid), or natural or synthetic esters (such as vegetable oils).

In a specific aspect, the fluid material can comprise a silicone fluid, for example a fluid poly(dimethyl siloxane). The fluid poly(dimethylsiloxane) is capable of flow at room temperature (e.g., 25° C.). For example, the fluid poly(dimethylsiloxane) can have a viscosity of less than 10,000 centistokes (cSt), for example less than 8,000 cSt, or 1,000 to 8,000 cSt, or 2,000 to 8,000 cSt, or 3,000 to 7,500 cSt, or 3,500 to 7,000 cSt. The poly(dimethylsiloxane fluid) may have any suitable end group, for example hydrogen, hydroxyl, alkyl, or vinyl end groups. Suitable poly(dimethylsiloxanes) are commercially available, for example, as the polymer base of SYLGARD 184 Elastomer Kit, commercially available from Dow Corning.

The ion barrier layer can comprise the fluid material as a uniform layer or in the form of a patterned layer. In an aspect, the ion barrier layer can comprise the fluid material as a uniform layer, for example as shown in FIG. 9 or FIG. 11. In a specific aspect, the ion barrier layer can comprise a liquid metal in the form of a uniform, continuous layer. In another aspect, the ion barrier layer can comprise a liquid metal in the form of a patterned layer. An example of a patterned layer is a hemiwicked layer or a self-supporting liquid metal layer, wherein the liquid metal is in the form of oxide-coated liquid metal droplets. A dielectric composite comprising a fluid self-supporting layer is shown in FIG. 16.

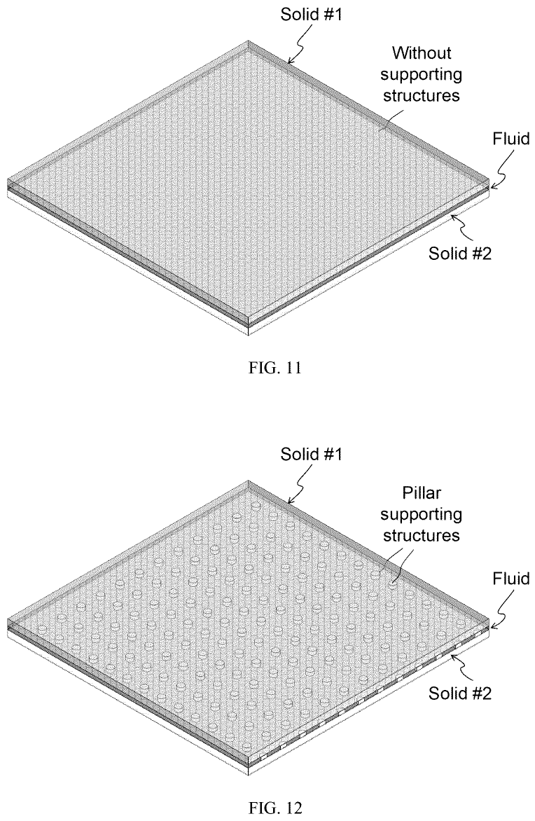

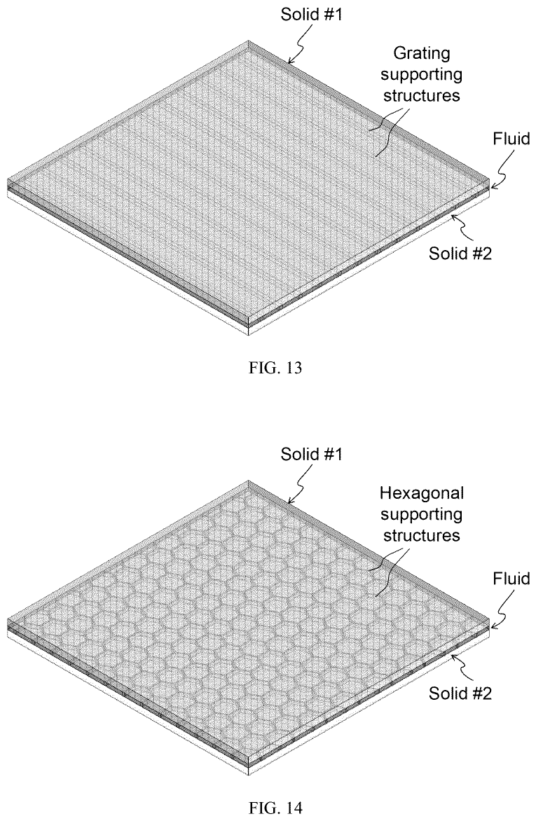

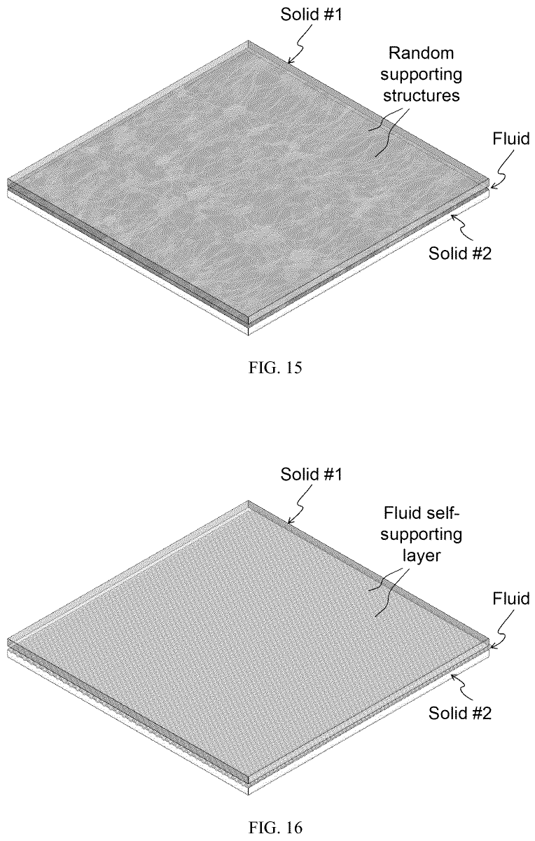

In an aspect, when the ion barrier layer comprises a liquid metal in the form of a patterned layer, a solid support material can be present, for example as shown in FIG. 10. In an aspect, when the ion barrier layer comprises a liquid metal in the form of a patterned layer, particularly when the patterned layer comprises the oxide-coated liquid metal droplets, a gaseous medium (e.g., air) can be packed around the droplets, and a solid support material may not be needed. When present, the solid support materials can be selected from those described above for the first and second solid layers. In particular, when present the solid support materials can be selected from a rubber, an elastomer, a rigid thermoplastic material, a rigid thermoset material, a ceramic material, or a combination thereof. In an aspect, the support material is not a hydrogel. Support materials may take a variety of forms, for example pillars (as shown in FIG. 12), grating supporting structures (as shown in FIG. 13), hexagonal structures (as shown in FIG. 14), and random supporting structures (as shown in FIG. 15).

Exemplary continuous and patterned layers are further shown and described in the working examples below.

The ion barrier layer can preferably have a thickness of greater than or equal to 0.3 nanometers (e.g., the ion barrier layer can be a single atom layer). For example, the ion barrier layer can be 0.3 nanometers to 5 millimeters. Within this range, the ion barrier layer can have a thickness of 0.3 nanometers to 50 micrometers, or 0.3 nanometers to 25 micrometers, or 0.3 nanometers to 15 micrometers, or 0.3 nanometers to 12 micrometers. Also within this range, the ion barrier layer can have a thickness of 500 nanometers to 10 micrometers. For example, the ion barrier layer can have a thickness of 100 micrometers to 5 millimeters, or 500 micrometers to 5 millimeters, or 1 millimeter to 5 millimeters. Thickness of up to 1 meter may be contemplated for certain applications.

In an aspect, when the ion barrier layer comprises a patterned fluid layer (e.g., a patterned liquid metal layer), the patterned layer comprises gaps between the liquid metal that are not larger than the ions for which ion impermeability is desired. Without wishing to be bound by theory, it is believed that the small gaps either do not allow the ion to pass through the layer or require a significantly long and complicated path for the ion to traverse the layer such that the layer remains substantially impermeable to the ion. If the liquid metal droplets (or other features of the liquid metal patterned layer) have gaps/spacings that are too large, then the composite will be ion permeable and accordingly cannot be a dielectric composite.

The ion barrier layer may be directly on the first and/or second solid layers, or an intervening layer may optionally be present. In an aspect, such intervening layers can include an adhesion promoting layer. For example, the dielectric composite can comprise an adhesion promoting layer disposed between the first solid layer and the ion barrier layer, the second solid layer and the ion barrier layer, or both. In an aspect, when present, the adhesion promoting layer can comprise a metal. Suitable metals can include but are not limited to gold and copper. In an aspect, the adhesion promoting layer can be gold. In an aspect, when present, the adhesion promoting layer can comprise a solid layer having a desired functional group on the surface, wherein the functional group is selected so as to improve the wettability of the ion barrier layer. Exemplary functional groups can include hydroxyl groups, amino groups, carboxyl groups, or a combination thereof. In an aspect, when present, the adhesion promoting layer can comprise a hydroxyl-functionalized surface of silicon dioxide (SiO₂), chromium, aluminum, titanium, etc. or an elastomeric surface such as PDMS. Hydroxyl functionalities can be incorporated, for example, by oxygen plasma treatment. In an aspect, the dielectric composite can exclude an adhesion promoting layer comprising a metal. In an aspect the dielectric composite can exclude an adhesion promoting layer comprising gold.

Though the particular selection of the components of the dielectric composite as described herein, the dielectric composite can advantageously be ion impermeable, nanoparticle impermeable, or both. The dielectric composite can be electrically insulating. The composite can prevent or reduce ion percolation into or through the dielectric composite. The composite can prevent or reduce corrosion of an underlying surface. In an aspect, the dielectric composite can maintain a conductivity of less than 0.2 siemens per centimeter (S/cm) for at least 12 hours in an ionic solution having a conductivity of greater than 0.2 S/cm.

A method of making the dielectric composite of the present disclosure is further described in the working examples below. In an aspect, a multilayered dielectric composite can be provided by stacking two or more layers of the dielectric composite as described herein.

The dielectric composites can find use in a variety of applications. For example, an article comprising the dielectric composite of the present disclosure can be, for example, a biosensor, a soft electronic device, a stretchable electronic device, a protective coating, a packaging material, an anti-corrosive coating, or a filter.

Another aspect of the present disclosure is a method of preventing ion permeation, the method comprising providing the dielectric composite of the present disclosure. The dielectric composite can preferably be disposed between an ion-rich environment and an ion-depleted environment, wherein substantially no ion permeation through the dielectric composite occurs.

This disclosure is further illustrated by the following examples, which are non-limiting.

### EXAMPLES

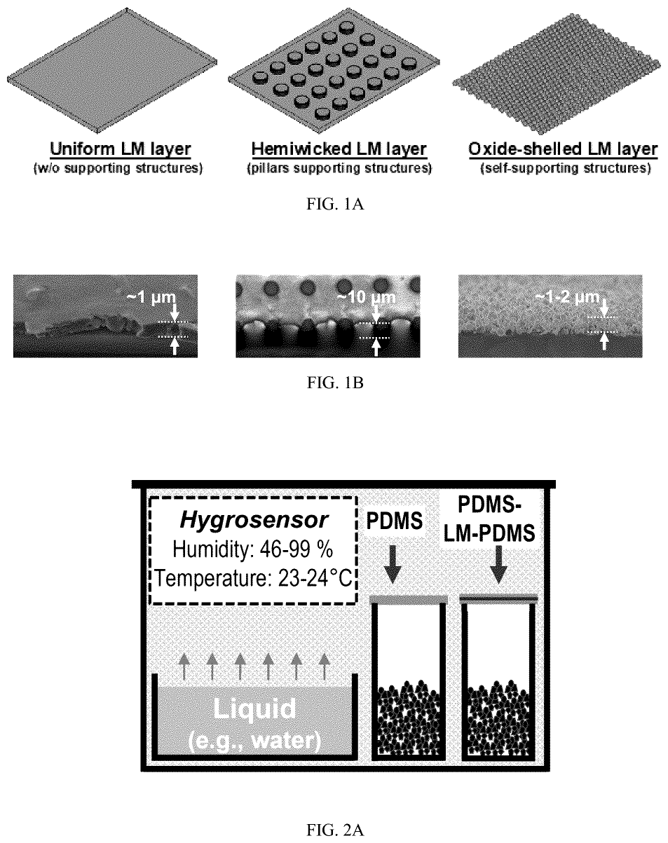

Gallium-based liquid metal was provided as a layer on gold surfaces or oxygen plasma activated PDMS surfaces. Uniform layers were fabricated using spin coating. Hemiwicked and nanodroplet layers were also prepared. A schematic illustration of each type of layer is shown in FIG. 1A, and the structures were confirmed by scanning electron microscopy (SEM), shown in FIG. 1B.

Experimental details for a liquid metal layer preparation for the fluid layer for was as follows: A continuous LM layer was prepared by putting a large LM droplet on an adhesion promotion layer such as gold surface or hydroxyl terminated surface and wait for the LM to wet the surface before spin coating to remove excessive LM and form a thin layer. The gold surface (100 nm) was prepared by e-beam evaporation with chromium as the adhesion layer (10 nm). A hydroxyl terminated surface was prepared by oxygen plasma (80 W, 500 mtorr, 30 seconds) on an oxide surface such as silicon dioxide (SiO₂), chromium, aluminum, titanium, etc. or an elastomeric surface such as PDMS (e.g., Ecoflex, CY52-276). Spin coating speed could be varied from 1000 to 10,000 rpm depending on the sample size and desired thickness of final LM layer. A hemiwicked LM layer was prepared by first forming supporting structures on top of the bottom solid layer and coat an adhesion promotion layer using the same method used to form a continuous LM layer. The hemiwicked LM layer was removed by scraping excess LM using a razor blade or a thin PDMS slab after LM wetting into the structures to reach a Wenzel wetting state. A self-supporting LM structural layer was formed by dispersing LM nanodroplets on the bottom solid surface. LM nanodroplets were formed by putting a large LM drop in such as IPA, with and use a probe sonicator to break it down into small droplets. Concentrated LM nanodroplets in IPA were spun or dipped coated on the bottom solid surface and the native oxide of the LM maintains its shape preventing droplets merging and supporting them into a layer structure.

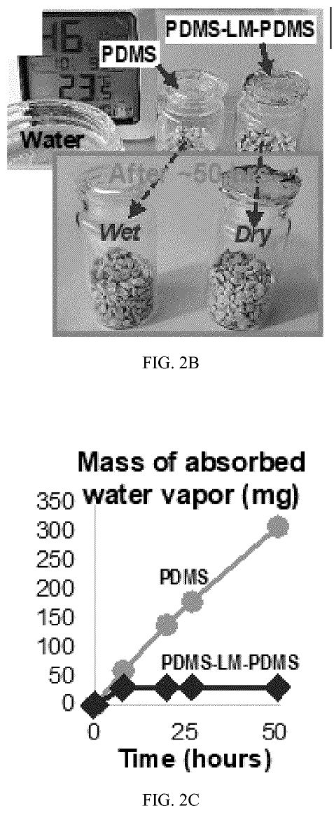

The layers were tested for water vapor permeability. To quantify the permeability of liquid vapor, a dry-cup method was used, as shown in FIG. 2A. A thin LM film on a polymer was prepared by the fabrication processes described above and then encapsulated by another layer of polymer. This composite film was then transferred to cover and seal a glass cup containing desiccants (e.g., CaSO₄) using oxygen plasma bonding or super glue. The temperature and humidity was monitored and maintained (e.g., 23° C., 100% relative humidity). The experimental apparatus is shown in FIG. 2B. An analytical balance with 10 mg precision was used to measure the increase in weight to quantify the liquid's vapor permeability.

Results are shown in FIG. 2C. As shown in FIG. 2C, while PDMS was confirmed permeable to water vapor, the PDMS-LM-PDMS film succeeded in preventing vapor from passing through it. In addition to the color change of the desiccants, the mass of the bottles was monitored to support this conclusion.

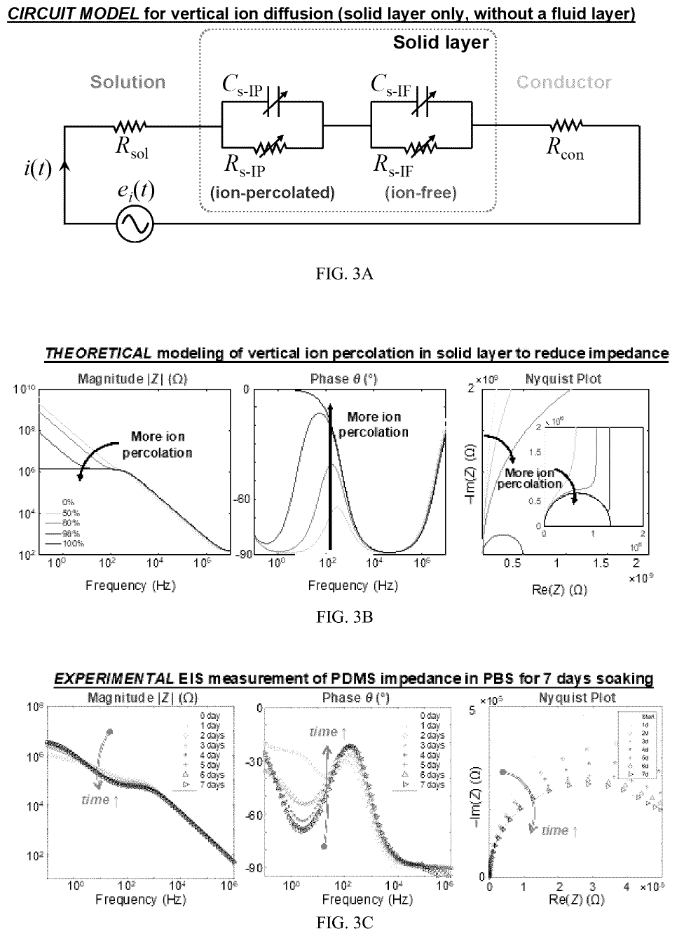

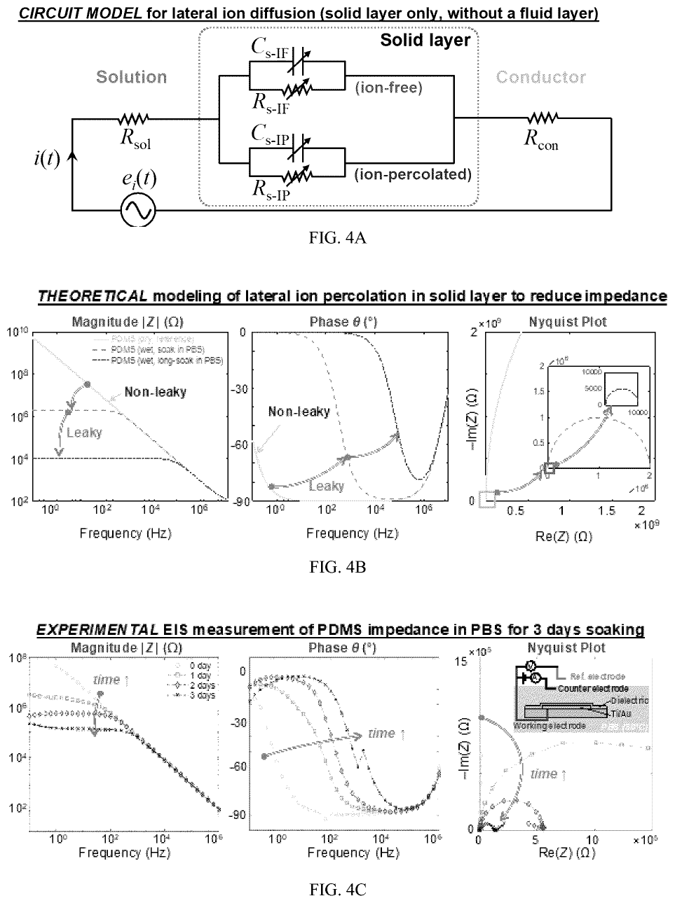

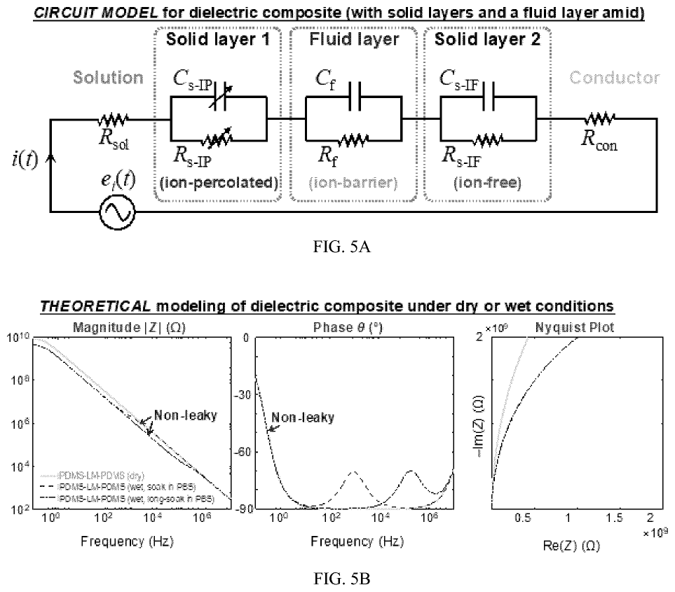

Pilot theoretical modeling, numerical simulation, and experimental electrochemical impedance spectroscopy (EIS) measurements were conducted. The circuits used for theoretical modeling are shown in FIG. 3A, FIG. 4A, and FIG. 5A. The overall impedance was calculated using the complex impedance method and the ion concentration of the solid layers from literature. EIS experiments to measure the impedance were performed using 3-electrode cells with a potentiostat (Gamry Reference 600), as shown in the inset of FIG. 4C. PDMS was chosen as the solid material for characterization of the ion percolation and impedance degradation. A PDMS layer with several micrometer thickness was spun coated on a 1×1 cm² gold electrode on a silicon substrate with 2 μm oxide. The gold electrode was deposited by e-beam evaporation with a chromium adhesion layer. To eliminate the potential effect from water diffusion and polymer swelling, all devices were soaked in DI water for a week before EIS measurements.

As shown in FIG. 3A and 3B, and FIG. 4A and 4B, circuit modeling and simulation of the ion percolation in both the vertical and lateral directions confirmed that ion diffusion from the high conductivity solution would decrease the impedance of a solid layer. EIS measurements shown in FIG. 3C and FIG. 4C accurately captured the dielectric degradation in PBS and were highly consistent with the modeling in FIG. 3A and FIG. 4A. In contrast, as shown in FIG. 5A, circuit modeling confirmed that the proposed solid-fluid-solid layer-stack (dashed lines) can maintain its impedance even when it is soaked in phosphate buffered saline (PBS) for a long time. Without wishing to be bound by theory, it is believed this is because the ion barrier fluid layer (e.g., LM) effectively blocks the ion percolation and maintains the inner solid layer (e.g., PDMS, hydrogel) ion-free and thus with high impedance.

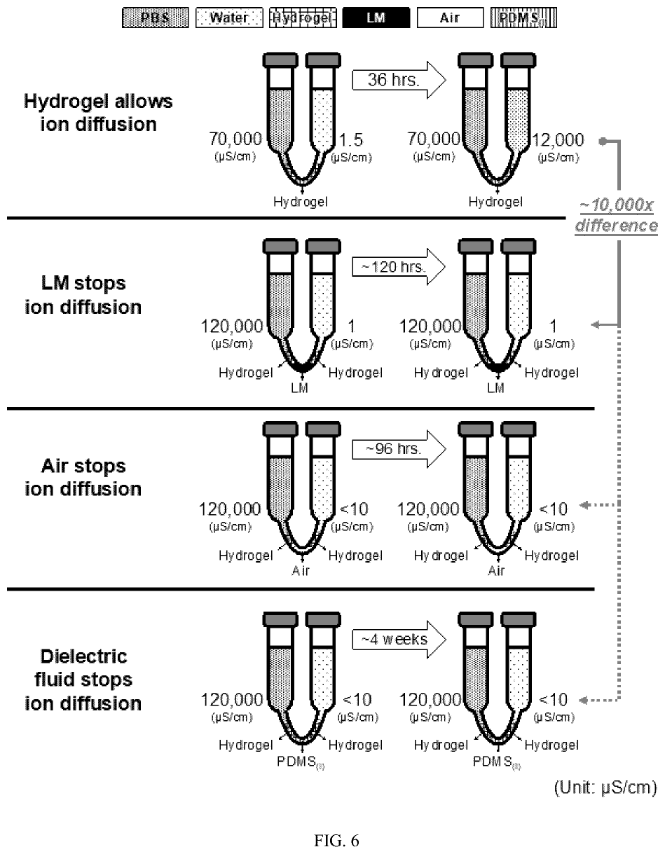

An experimental design to verify the ion impermeability of the dielectric composite is shown in FIG. 6. Hydrogels were used as the solid layers and liquid metal (LM), air, and dielectric fluid (PDMS fluid having a viscosity of 4,000 to 6,500 cSt at 23° C., obtained as the base polymer of SYLGARD184) were used as the fluid layer to test their ion impermeability capability.

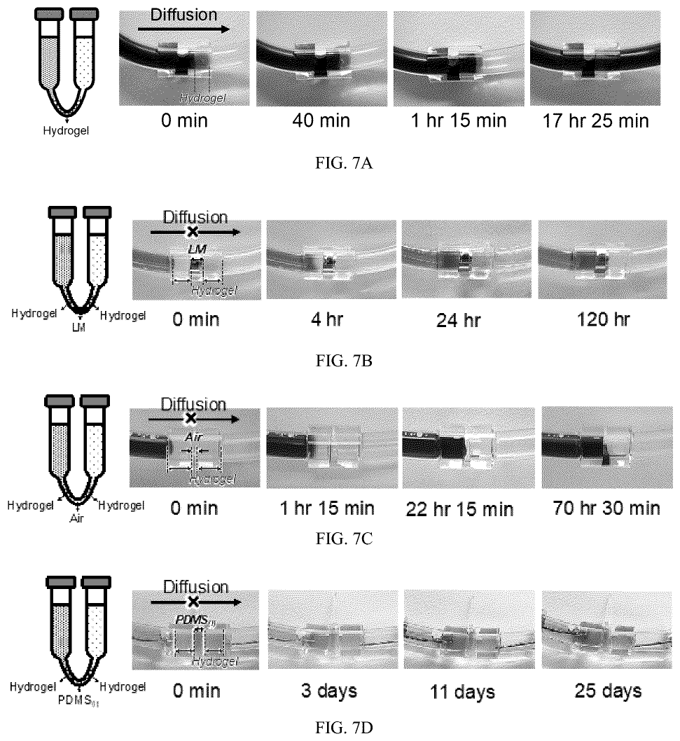

Different layers were tested for their permeability to dye nanoparticles. The color of the water was compared for four cases: (1) a reference setup with hydrogel as the solid layer without a fluid ion barrier layer; (2) a test setup with hydrogel as the top and bottom solid layers with LM as the middle fluid layer (i.e., hydrogel-LM-hydrogel), (3) a test setup with hydrogel as the top and bottom solid layers with air as the fluid middle layer (i.e., hydrogel-air-hydrogel), and (4) a test setup with hydrogel as the top and bottom solid layers with PDMS fluid (i.e., base polymer of SYLGARD 184) as the fluid middle layer (i.e., hydrogel-PDMS-hydrogel). As shown in FIG. 7A-7D, the reference with only a hydrogel layer allows the blue dye to diffuse from left to right and turns the right-side water connected to the hydrogel blue. In contrast, the hydrogel-LM-hydrogel layers, the hydrogel-air-hydrogel layers, and the hydrogel-PDMS-hydrogel layers stop the dye diffusion and maintain the right-side water clear even after a much longer duration (i.e., at least 4-5 fold).

Experiments to verify the ion impermeability were conducted according to the following procedure. The PVA hydrogel was fabricated using liquid polyvinyl alcohol (PVA) pregel solution, crosslinker, and catalyst. The PVA pregel solution was prepared by making a 10 wt. % solution of PVA (molecular weight of 130,000) flakes in deionized water (DIW). The mixture was heated in a water bath while stirring continuously at 95° C. for at least 5 hours or until a homogeneous pregel solution was achieved. The pregel solution was cooled to room temperature before further processing. For each batch of PVA hydrogel, 2 portions of 3 ml PVA pregel were collected in a cup using a syringe. Glutaraldehyde and concentrated hydrochloric acid were used as a crosslinker and catalyst respectively and were each added to pregel in a 100:1 (PVA pregel to crosslinker/catalyst) ratio and mixed and degassed in a planetary mixer for 50 to 75 seconds. Further, equal weights of both the mixtures were mixed and degassed again at 2300 revolutions per minute (rpm) for 1 min to start the crosslinking process which requires approximately 10 minutes until it is completely crosslinked and cannot be modified in shape any further. After mixing, the mixture was immediately filled inside a syringe to pump slowly into flexible tubes up to 5 mm depth from the end ensuring no bubbles were formed. Another hydrogel combining PVA with polyacrylamide (PAAm) was also prepared. For PVA-PAAm composite hydrogel, PVA mixture was prepared as described here. Simultaneously, a PAAm solution was prepared by dissolving the acrylamide (AAm) monomer into DIW in the weight ratio of 2:1. Separately, crosslinker and UV initiator solutions of 0.1 M concentrations were prepared in DIW and ethanol, respectively. The crosslinker and initiator solutions were added to the PAAm solution such that the molar ratio of crosslinker to acrylamide monomer was maintained at 8×10⁻⁴ and molar ratio of initiator to crosslinker was maintained at 0.4. This acrylamide solution was mixed for 10 seconds using a vortex mixer. The acrylamide solution was mixed with the PVA mixture in the weight ratio of 1:2 and mixed and degassed again at 2300 rpm for 1 minute. After mixing, the mixture was immediately filled inside a syringe to pump slowly into flexible tubes up to 5 mm depth from the end ensuring no bubbles were formed and exposed to UV radiation for 10 minutes at the intensity of 16 mW/cm2 until it was completely crosslinked and cannot be modified in shape any further. After the hydrogel was crosslinked completely, it was soaked in DIW for at least 12 hours to achieve a swollen state before it was used for experiments. The test setup was designed in a “bridge” manner as shown in FIG. 6. Two tubes with ID Φ4 and OD Φ8 mm were filled with PVA hydrogel at one end for a length of ˜5 mm. A ˜1 cm long rigid “bridge” tube of ID @8 mm was used to contain the test material while forming a tight fit when the tubes containing PVA hydrogel were inserted. To create the dielectric composite with a fluid layer amid, the rigid “bridge” tube was attached to one of the PVA hydrogel tubes and formed a tight fit. The fluid material, either LM, air, or dielectric fluid (e.g., PDMS base polymer) was filled from the open end of the rigid tube. Lastly, the second tube containing PVA hydrogel was inserted into the rigid tube and squeezed the fluid material, and formed a uniform layer (i.e., disk-like) with a tight seal for long-term testing. Conical end vials (e.g., with 50 ml volume) were used as fluid reservoirs to contain the high/low conductivity medium (i.e., PBS or DIW). The vials were modified to have pipette tips at the end so that an easy tight seal could be formed with various tubes by simple plugging and ready for ion permeability tests. The fluids were filled in the tubes making sure no air bubbles or voids were formed which could interfere with the conductivity measurement. The high conductivity fluid (PBS 1M or PBS 10X) was measured before the experiment using a conductivity meter (Apera 9500) for reference. Once the experiment was set up, the conductivity meter was placed in the DIW reservoir and measured conductivity every minute, continuously. Different colors of dyes were mixed in the PBS solution (acid blue 9/Brilliant Blue FCF) and the PVA pregel solution (rhodamine B) to visualize the diffusion between PBS and water. Pictures of the “bridge” with the testing solid/liquid layers were captured from time to time to record the diffusion behavior of dyes.

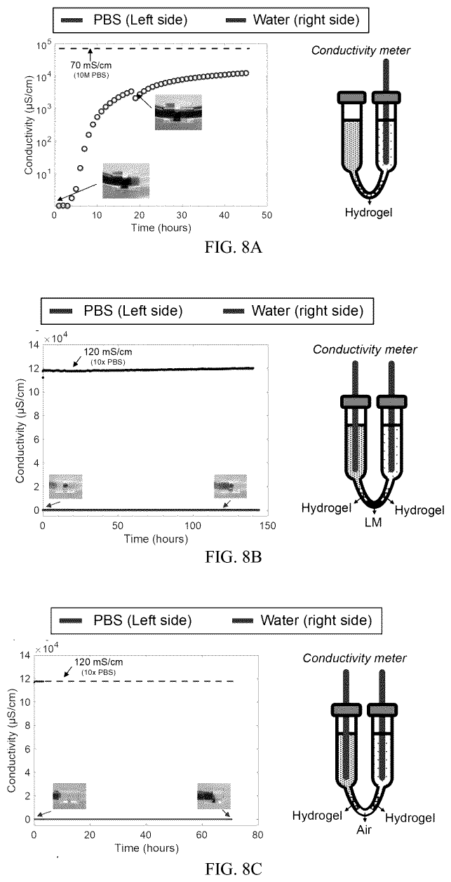

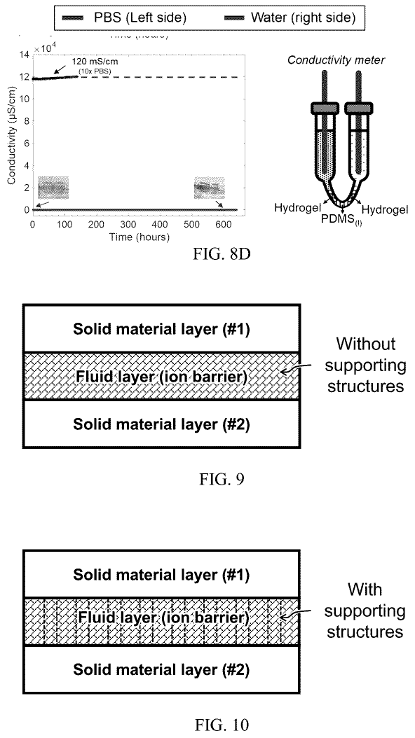

Different layers were tested for their ion impermeability. Specifically, the conductivity of water was compared for four cases: (1) a reference setup with hydrogel as the solid layer without a fluid ion barrier layer, (2) a test setup with hydrogel as the top and bottom solid layers with LM as the fluid middle layer (i.e., hydrogel-LM-hydrogel), (3) a test setup with hydrogel as the top and bottom solid layers with air as the fluid middle layer (i.e., hydrogel-air-hydrogel), and (4) a test setup with hydrogel as the top and bottom solid layers with PDMS fluid as the fluid middle layer (i.e., hydrogel-PDMS-hydrogel). As shown in FIG. 8, the reference with only a hydrogel layer allows ions to diffuse from left to right and increases the water conductivity from a low value (e.g., ˜1-2 μS/cm) dramatically for ˜10,000 folds (e.g., 12,000 μS/cm) within 36 hours. In contrast, the hydrogel-LM-hydrogel layers, the hydrogel-air-hydrogel layers, and the hydrogel-PDMS-hydrogel layers stop the ion diffusion and maintain the conductivity of the right-side water at the same levels (i.e., a few μS/cm) even after an extended period (e.g., 96 hours to 4 weeks) while the left-side PBS has a conductivity that is 4-5 orders of magnitudes higher (i.e., more than 100 mS/cm).

This disclosure further encompasses the following aspects.

Aspect 1: A dielectric composite comprising: a first solid layer; an ion barrier layer comprising a fluid material on the first layer; a second solid layer on the ion barrier layer on a side opposite the first solid layer; wherein the ion barrier layer is encapsulated by the first and second solid layers; and wherein the dielectric composite is ion impermeable, nanoparticle impermeable, or both.

Aspect 2: The dielectric composite of aspect 1, wherein the first solid layer and the second solid layer are the same or different and wherein the first solid layer and the second solid layer are each independently selected from rigid or soft materials.

Aspect 3: The dielectric composite of any of aspects 1 to 2, wherein the first solid layer and the second solid layer are each independently selected from a hydrogel, a rubber, an elastomer, a rigid thermoplastic material, a rigid thermoset material, or a ceramic material.

Aspect 4: The dielectric composite of any of aspects 1 to 3, wherein the first solid layer and the second solid layer each independently comprise a hydrogel, preferably a hydrogel comprising poly(vinyl alcohol) (PVA), polyacrylamide (PAAm), polyethylene glycol diacrylate (PEGDA), alginate, or a combination thereof.

Aspect 5: The dielectric composite of any of aspects 1 to 3, wherein the first solid layer and the second solid layer each independently comprise an elastomer, preferably an elastomer comprising polysiloxane, polydimethylsiloxane, silicone, polyurethane, polyacrylate, natural latex rubber, block copolymer elastomers, poly(styrene-ethylene-butylene-styrene), thermoplastic elastomers, propylene-ethylene copolymer, fluoroelastomers, or a combination thereof, preferably polydimethylsiloxane.

Aspect 6: The dielectric composite of any of aspects 1 to 3, wherein the first solid layer and the second solid layer each independently comprise a rigid thermoplastic material or a rigid thermoset material, preferably polytetrafluoroethylene (PTFE), poly(methyl methacrylate) (PMMA), polyimide (PI), or an epoxy.

Aspect 7: The dielectric composite of any of aspects 1 to 3, wherein the first solid layer and the second solid layer each independently comprise a ceramic material, preferably silica or alumina.

Aspect 8: The dielectric composite of any of aspects 1 to 7, wherein the ion barrier layer comprises a fluid material comprising a liquid metal, a gas, a nonionic liquid, or a combination thereof.

Aspect 9: The dielectric composite of any of aspects 1 to 8, wherein the ion barrier layer comprises a fluid material comprising a liquid metal.

Aspect 10: The dielectric composite of aspect 9, wherein the liquid metal comprises gallium, indium, tin, bismuth, mercury, or an alloy thereof, preferably gallium alloys.

Aspect 11: The dielectric composite of any of aspects 1 to 8, wherein the ion barrier layer comprises a fluid material comprising a gas, preferably wherein the gas is air, oxygen, nitrogen, argon, or a combination thereof, more preferably air.

Aspect 12: The dielectric composite of any of aspects 1 to 8, wherein the ion barrier layer comprises a dielectric fluid comprising a fluorinated fluid, an organic fluid, or a combination thereof.

Aspect 13: The dielectric composite of any of aspects 1 to 12, wherein the ion barrier layer comprises a fluid material in the form of a uniform layer or wherein the ion barrier layer is a patterned layer.

Aspect 14: The dielectric composite of any of aspects 1 to 13, wherein the ion barrier layer further comprises one or more support materials.

Aspect 15: The dielectric composite of any of aspects 1 to 14, further comprising an adhesion promoting layer disposed between the first solid layer and the ion barrier layer, the second solid layer and the ion barrier layer, or both, preferably wherein the adhesion promoting layer comprises a metal, preferably gold or copper, or a solid layer comprising one or more functional groups capable of improving wetting of the ion barrier layer.

Aspect 16: The dielectric composite of any of aspects 1 to 15, wherein the composite excludes an adhesion promoting layer comprising a metal, preferably wherein the composite excludes an adhesion promoting layer comprising gold.

Aspect 17: The dielectric composite of any of aspects 1 to 16, wherein the ion barrier layer has a thickness of greater than or equal to 0.3 nanometers.

Aspect 18: The dielectric composite of any of aspects 1 to 17, wherein the dielectric composite maintains a conductivity of less than 0.2 S/cm for at least 12 hours in an ionic solution with a conductivity of greater than 0.2 S/cm.

Aspect 19: A dielectric composite comprising two or more layers, wherein each layer comprises the dielectric composite according to any of aspects 1 to 18.

Aspect 20: An article comprising the dielectric composite of any of aspects 1 to 19, preferably wherein the article is a biosensor, a soft electronic device, a stretchable electronic device, a protective coating, a packaging material, an anti-corrosive coating, or a filter.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A dielectric composite comprising:
a first solid layer;
an ion barrier layer comprising a fluid material on the first layer;
a second solid layer on the ion barrier layer on a side opposite the first solid layer;
wherein the ion barrier layer is encapsulated by the first and second solid layers; and
wherein the dielectric composite is ion impermeable, nanoparticle impermeable, or both.

2. The dielectric composite of claim 1, wherein the first solid layer and the second solid layer are the same or different and wherein the first solid layer and the second solid layer are each independently selected from rigid or soft materials.

3. The dielectric composite of claim 1, wherein the first solid layer and the second solid layer are each independently selected from a hydrogel, a rubber, an elastomer, a rigid thermoplastic material, a rigid thermoset material, or a ceramic material.

4. The dielectric composite of claim 1, wherein the first solid layer and the second solid layer each independently comprise a hydrogel.

5. The dielectric composite of claim 1, wherein the first solid layer and the second solid layer each independently comprise an elastomer.

6. The dielectric composite of claim 1, wherein the first solid layer and the second solid layer each independently comprise a rigid thermoplastic material or a rigid thermoset material.

7. The dielectric composite of claim 1, wherein the first solid layer and the second solid layer each independently comprise a ceramic material.

8. The dielectric composite of claim 1, wherein the ion barrier layer comprises a fluid material comprising a liquid metal, a gas, a nonionic liquid, or a combination thereof.

9. The dielectric composite of claim 1, wherein the ion barrier layer comprises a fluid material comprising a liquid metal.

10. The dielectric composite of claim 9, wherein the liquid metal comprises gallium, indium, tin, bismuth, mercury, or an alloy thereof.

11. The dielectric composite of claim 1, wherein the ion barrier layer comprises a fluid material comprising a gas.

12. The dielectric composite of claim 1, wherein the ion barrier layer comprises a dielectric fluid comprising a silicone fluid.

13. The dielectric composite of claim 1, wherein the ion barrier layer comprises a fluid material in the form of a uniform layer or wherein the ion barrier layer is a patterned layer.

14. The dielectric composite of claim 1, wherein the ion barrier layer further comprises one or more support materials.

15. The dielectric composite of claim 1, further comprising an adhesion promoting layer disposed between the first solid layer and the ion barrier layer, the second solid layer and the ion barrier layer, or both.

16. The dielectric composite of claim 1, wherein the composite excludes an adhesion promoting layer comprising a metal.

17. The dielectric composite of claim 1, wherein the ion barrier layer has a thickness of greater than or equal to 0.3 nanometers.

18. The dielectric composite of claim 1, wherein the dielectric composite maintains a conductivity of less than 0.2 S/cm for at least 12 hours in an ionic solution with a conductivity of greater than 0.2 S/cm.

19. A dielectric composite comprising two or more layers, wherein each layer comprises the dielectric composite according to claim 1.

20. An article comprising the dielectric composite of claim 1.
